(19) United States
(12) Patent Application Publication
(10) Pub. No.: US 2019/0094397 A1
(43) Pub. Date: Mar. 28, 2019

(54) SURFACE DETECTION AND LOCATION OF MICROSEISMIC EVENTS AND EARTHQUAKES WITHOUT THE USE OF A VELOCITY MODEL

(71) Applicants: Jie Zhang, Houston, TX (US); Wei Zhang, Hefei (CN); Xiong Zhang, Hefei (CN)

(72) Inventors: Jie Zhang, Houston, TX (US); Wei Zhang, Hefei (CN); Xiong Zhang, Hefei (CN)

(73) Assignee: REAL TIME GEOMECHANICS, LLC, Houston, TX (US)

(21) Appl. No.: 16/141,194

(22) Filed: Sep. 25, 2018

Related U.S. Application Data
(60) Provisional application No. 62/562,947, filed on Sep. 25, 2017.

(51) Int. Cl. G01V 1/28; E21B 43/26; G01V 1/30; G01V 1/18

(52) U.S. Cl. CPC G01V 1/288; G01V 1/181; G01V 1/305; E21B 43/26

(57) ABSTRACT

A system and method for hydraulic fracturing and monitoring microseismic events related to hydraulic fracturing are described. One method describes a method of hydraulic fracturing gas production comprising drilling and casing a gas production well with a horizontal section within a formation layer, perforating the horizontal section of the well at a known location, and monitoring the resulting seismic waves using an array of geophones. Using the seismic waves resulting from the perforation shot, subsequent microseismic events may be located using a root mean square velocity and average velocity and without the use of a depth velocity model.

### CROSS REFERENCE TO RELATED APPLICATIONS

This application claims the benefit of U.S. Provisional Application Ser. No. 62/562,947, filed Sep. 25, 2017. Applicant incorporates by reference herein Application Ser. No. 62/562,947 to the extent it is not inconsistent with this application.

### FIELD OF THE INVENTION

The invention is related to hydraulic fracturing and seismic event detection and location. The invention enables detection, monitoring, and/or locating microseismic events or small earthquakes associated with hydraulic fracturing, unconventional oil and gas production, mining, geothermal activities and/or industry activities as well as natural earthquakes without the use of a depth velocity model.

### BACKGROUND AND SUMMARY

Passive microseismic (surface-wave magnitude Ms from −3 to 0) and small earthquake (Ms from 0 to 3) monitoring has been widely utilized in many fields, including, for example, shale oil and gas production, mining, and geothermal activities. Microseismic event locations offer information related to fracture occurrence in a reservoir during shale gas production. It is believed that oil and gas production activities induce small to medium magnitude earthquakes, which are a potential threat to the public. The traditional method of locating seismic events relies on the use of a depth velocity model. Using a depth velocity model, one can utilize recorded waveform data or picked travel times of the P and S waves to determine the event locations and depth.

For the travel time method, a common approach for locating events is to utilize a grid search method with the picked arrival times from data. Monitoring receiver arrays or stations may be placed on the surface or downhole. Under certain conditions, surface monitoring may better define the horizontal positions of events, while downhole monitoring may record smaller events at shorter distance. For surface monitoring, however, the recorded signals may be too weak because of stronger attenuation in the near surface area, and longer propagation path of seismic waves. The P and S arrivals may not be detected well on individual receivers at the surface.

The location techniques for surface monitoring usually involve stacking or time-reverse modelling; thus, the arrival time picking can be avoided. The waveform data recorded on the surface can be back propagated to the origin of the source by the time-reverse modelling methods using a depth velocity model.

For the source scanning methods, the travel time table for the potential locations on the spatial grid can be calculated in advance, and the energy at each location node can be evaluated by stacking the waveforms along the travel time curve of all the receivers. The node with the maximum stacking amplitude is then automatically assigned to the likely event location.

The above methods require a depth velocity model, consisting of a number of geological layers or structures, and each layer or structure is characterized by a pair of seismic P-wave and S-wave velocities. This depth velocity model may be critical to the accuracy of the location results. A depth velocity model may initially be derived from well logs, but may then need to be calibrated using seismic data from perforation shots. In some circumstances, a velocity model derived from well logs may not be accurate enough for the event location since the well logs are influenced by many extraneous factors, such as pore pressure, stress accumulation, and mud invasion. The frequency of well log data is also significantly higher than the frequency of microseismic data. In addition, the velocities derived from well logs only reflect the values around the well, but the ray paths of the microseismic waves commonly cover the area from the receiver to the event location. Generally, the depth velocity model is one-dimensional and the model can be initially derived from well logs but the velocities should be further calibrated with the perforation shots. With the arrival times of the perforation shot, a grid search method can be utilized to optimize the velocity values in each layer through fitting the arrival times. Other global optimization methods such as simulated annealing and neural network methods can be applied to speed up the searching process and avoid searching the entire model space. Nevertheless, under some conditions, the velocity model may be still poorly constrained due to limited data coverage and the poor quality of perforation shot data recorded on the surface. Under conditions with a low signal to noise ratio, it may be impossible to manually select the direct P-waves. In such conditions, the traditional travel time grid search for a layered velocity model may be impossible.

In this invention, we present a method to detect and locate seismic events (microseismic or small to medium earthquakes) from surface recordings without the use of or in the absence of a depth velocity model. Instead, we use a single root mean square (“RMS”) velocity to locate events in the X and Y dimensions as well as in Time. The RMS velocity is the function of a series of interval velocities in depth. However, we do not need to use the depth interval velocities to calculate the RMS velocity. Since the RMS velocity is a single number, we can scan a range of possible RMS velocity values and obtain the value that produces the best stacking image for perforation shot data. This number is the correct RMS velocity from the surface to the perforation depth. We then use this RMS velocity for later event detection and location. Using an average velocity, we will then convert the stacking image in X, Y, and Time to X, Y, and Z. An average velocity can be estimated using the vertical travel time (tt₀) and the known depth of the perforation shot (h):Vₐ=h/tt₀. The vertical travel time (tt₀) is obtained from scanning the semblance equation (6) described below.

For microseismic monitoring, we may estimate a RMS velocity for each stage of hydraulic fracturing using perforation shots or drop-ball data. We may also select a few well located microseismic events as reference events at resolved locations to estimate RMS velocities in time. Regardless, detecting and locating each microseismic event only requires a single RMS velocity.

Time Versus Depth Imaging

In conventional surface seismic imaging, time imaging and depth imaging are two different branches of imaging methods. The output of time imaging is in (x, y, t), versus the output of depth imaging is in (x,y,z). The output of time imaging needs to be converted to depth (z) in the end for interpretation. Time imaging is generally easier than depth imaging to conduct, and the quality of time image is also better. This is because the RMS velocity field needed for time imaging is much easier to construct than the depth (interval) velocity model for depth imaging. Depth imaging is ultimately desired, especially for complex structures, since the imaging result tells the structures in the true 3D earth. However, without accurate depth velocity model, depth imaging (migration) cannot produce a clear subsurface image. In the current industry practice, both time and depth imaging are needed for quality control and these two methods need to be generally consistent. Time imaging generally assumes less lateral variations in the subsurface structures, while depth imaging may be more robust when dealing with complex structures. Hydraulic fracturing is often conducted in areas with limited lateral variations in the subsurface structures, therefore, time imaging assumption are generally considered to be valid. Disclosed embodiments address the problem of microseismic event location utilizing time imaging methodologies with unique microseismic issues and solutions.

Time imaging methodologies are generally considered easier and more appropriate than depth imaging for imaging microseismic events using surface recordings.

Since microseismic events and perforation shots all occur more or less at the same depth level, only a single RMS velocity is needed for imaging events in time. The details of the velocity sequence and thicknesses of intermediate geological layers do not generally impact time imaging methodologies. But for depth imaging, the velocity model must be sufficiently accurate. This means the thickness and velocity of each layer above the event depth must be accurate, and the sequence of the layers above the event depth must be precisely correct. Disclosed embodiments allow for accurate location of microseismic events without the time consuming and costly necessity of accurately establishing the thickness and velocity of each geological layer above the event depth.

Disclosed embodiments utilize a form of time imaging methodologies. Traditional time imaging has been used for surface reflection survey, however, in traditional time imaging, both the source of seismic waves and the receivers are at known locations and the reflection waves are utilized to locate subsurface reflectors. Unlike traditional time imaging methodologies, disclosed embodiments relate to the location of an unknown source of microseismic waves utilizing the direct seismic waves from that source. This is a completely different problem and requires a completely different solution as compared to traditional time imaging methodologies. Additionally, traditional time imaging methodologies attempt to locate subsurface reflectors. Many disclosed embodiments utilize techniques which obviate or eliminate the need to study the specific boundaries of subsurface strata and reflectors which traditional time imaging methodologies are focused on.

### BRIEF DESCRIPTION OF THE DRAWINGS

For a detailed description of various embodiments, reference will now be made to the accompanying drawings in which:

FIGS. 1A and 1B show a version of a time imaging methodology compared to a depth imaging methodology.

FIG. 2 shows the schematic for the time parameters. The triangles and the star denote the receiver array deployed on the surface and the source. The red dots represent the arrival time of the P wave (tₚ). tt₀ is the vertical travel time from source to surface, t′ₚ is the clock arrival time of tt₀. h is the depth of the source, and Vₐ is the average velocity, and Bᵣₘₛ is the RMS velocity

FIGS. 3A, 3B, and 3C show the RMS and average velocity analysis. The grayscale in the first panel a) represents the value of the vertical travel time tt₀; the grayscale in the second panel b) denotes the semblance value. The location of the cross in b) is the picked RMS velocity with the largest semblance value. The vertical travel time is read at the same picked point (cross) in panel a). The dots in panel c) are the arrival times calculated from the picked point.

FIGS. 4A and 4B shows the schematic for the stacking procedure. The triangles denote the receivers deployed on the surface, and the solid circles are the locations of an event. (a) The waveforms recorded by the four receivers. (b) The waveforms after normal move out by calculating the arrival time with the RMS velocity, and the statics can be obtained by the correlation between the stacked trace with the four waveforms.

FIG. 5 The geometry distribution. The triangles represent the receivers deployed on the surface. The star denotes an event with known location (e.g., perforation shot).

FIG. 6 shows the perforation data with known location. The arrival time curve is calculated with a determined RMS velocity.

FIG. 7 shows the stacking image for the RMS and average velocity analysis. The star denotes the picked maximum stacking value.

FIG. 8 shows the continuous data records that include 9 microseismic events. With the stacking approach and a threshold set for event detection. The arrival time curves are associated with the best event locations.

FIG. 9 shows a stacking curve and detection results for nine events. The amplitude peak (maximum semblance value) in the top plot corresponds to the detected events. At each time point t′ₚ, a set of (sₓ, s_{y}, tt₀) is returned for the relatively large stacking energy. The set of the location parameters corresponding to the amplitude larger than the preset threshold in the stacking curve is the solution for that event. The bottom curve tt₀ is converted to depth with an average velocity.

FIG. 10 shows the stacking image for a detected event. The triangles denote the receivers on the surface.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . . “Also, the term “couple” or “couples” is intended to mean either an indirect or direct connection. Thus, if a first device couples to a second device, that connection may be through a direct connection or through an indirect connection via other devices and connections.

While all of the terms used in this description will be understood by the ordinary artisan, for the avoidance of doubt, as used in this disclosure, “Hydraulic fracturing” shall mean injecting liquid including but not limited to water or fracturing fluid, with or without chemical additives and/or proppants into a formation. “Microseismic events” shall mean small earthquakes less than about zero on the Richter scale; “Average velocity” (Va) shall mean the velocity through a number of layers, which is the total distance divided by the total travel time of a wave; and “Interval velocity” (Vint) shall mean the seismic velocity over a depth interval z. If the rock type is uniform through that depth interval, then Vint is equal to the formation velocity. If the depth interval covers a number of rock beds, then the interval is equal to the average velocity (Va) calculated over the distance z.

It will be understood that, while the invention is described in exemplary terms related to a microseismic monitoring problem during hydraulic fracturing for shale oil and gas production, embodiments, are also applicable to monitor mining, geothermal activities, induced seismicity, and/or natural earthquakes.

Hydraulic fracturing is typically designed with multiple stages or sections along a vertical or horizontal well, followed by perforation shots. The “horizontal” section of a well is not limited to being strictly horizontal but is understood to be any section that is not vertical. A perforation shot typically makes several holes in the well casing, which allow injection fluid to penetrate into the surrounding rocks under pressure and cause fracturing. The location of perforation shots is generally known, but the precise occurrence time may or may not be known. For surface monitoring, we typically record the seismic data of the perforation shots at the surface.

In some embodiments, microseismic monitoring may allow for improved production from hydraulically fractured wells. Microseismic monitoring can help to identify patterns and locations of fracture propagation and/or development as well as fluid movement patterns. This information may assist the operator in understanding a well and/or a formation and lead to improved well and stage placement.

When monitoring microseismic events from the surface during hydraulic fracturing, an array of receivers may be placed on the surface or buried in the shallow depth following designated locations. If the surface presents varied topography, elevation statics corrections may be calculated and applied in order to improve data and/or signal processing. In some embodiments, a receiver array continuously records the seismic waves from subsurface events including, but not limited to cracking, fracturing, rock faulting, and/or other seismic wave generating events.

In some embodiments, the length of a receiver array is at least at as great as the depth of a seismic event, or at least 130% of the depth of a seismic event, or at least 150%, or at least 170%, or at least 190%, or at least 200%, or at least 220%, or at least 250%, or at least 300% of the depth of a seismic event. In other embodiments, the length of a receiver array is at most at as great as the depth of a seismic event, or at most 130% of the depth of a seismic event, or at most 150%, or at most 170%, or at most 190%, or at most 200%, or at most 220%, or at most 250%, or at most 300% of the depth of a seismic event. In preferred embodiments, the length of the receiver array is approximately two times the event depth.

A perforation in the context of oil wells refers to a hole punched in the casing and/or liner of an oil well to allow access to the structure or reservoir. In cased hole completions, horizontal or vertical wells may be drilled into the section of the formation desired for production and may have casing or a liner run in, thereby separating the formation from the well bore. A final stage of well completion may involve running in perforating guns, which are typically a string of shaped charges, down to the desired depth and/or position and activating the charges to perforate the casing or liner. A typical perforating gun can carry many dozens of explosive charges. The action of a perforation is like a shot, creating seismic waves which may be recorded by a monitoring receiver array.

When a perforation shot (or other reference shot) for hydraulic fracturing is executed and recorded, the data may be recorded and processed to prepare parameters for the subsequent microseismic monitoring. Three such parameters include (1) receiver residual statics, (2) a RMS velocity (Vᵣₘₛ) and (3) an average velocity (Vₐ). A reference shot is not limited to a perforation shot, a reference shot may include, but is not limited to a perforation shot, drop-ball event, or any other microseismic event with a known location. Many disclosed embodiments require these three parameters for microseismic event (or earthquake) detection and location although the use of receiver residual statics is not always necessary. Obtaining the above parameters is easier and faster than developing a depth velocity model. Disclosed embodiments save time, processing power, energy, and cost over conventional seismic monitoring methods. Disclosed methods also allow for the monitoring and location of microseismic events without the rigorous and detailed development of a depth velocity model or otherwise solving for depth velocity. Disclosed embodiments allow for determining the location of microseismic events without the use of or in the absence of a depth velocity model. It will be understood that disclosed embodiments do not require a depth velocity model but may include a depth velocity model. Disclosed embodiments allow for the location of microseismic events by addressing the large amount of noise associated with perforation shots which can frustrate traditional methods. Additionally, utilizing some disclosed embodiments allows for real-time or near-real-time monitoring as opposed to some previous methods which required multiple days and even weeks of calculation efforts before providing using reporting of microseismic events. In some disclosed embodiments, monitoring of microseismic events and/or mapping the development of fractures may be partially or entirely automated.

RMS Velocity and Average Velocity

We utilize a RMS velocity instead of a layered depth velocity model to detect and locate the event. Assuming the event is located at the bottom interface of the nth layer, the effective RMS velocity Vᵣₘₛ and average velocity Vₐ from the source to surface is defined as following equation 1:

$$\{ \begin{matrix}{V}_{rms} = \sqrt{\frac{{\sum }_{i}^{n} {V}_{i}^{2} Δ {t}_{i}}{{\sum }_{i}^{n} Δ {t}_{i}}} \\ {V}_{a} = \frac{{\sum }_{i}^{n} {V}_{i} Δ {t}_{i}}{{\sum }_{i}^{n} Δ {t}_{i}}\end{matrix} ,$$

In equation 1, Vᵢ is the interval velocity in the ith layer; Δtᵢ is the vertical travel time in ith layer. The RMS velocity is related to all of the interval velocities and vertical travel times above the source depth. We will use the RMS velocity to stack energy over many traces following reflection seismology, and we will use an average velocity to convert “vertical time” of an event to depth. Since is a single number, we do not need to actually calculate Vᵣₘₛ using equation (1). In practice, we can scan a range of Vᵣₘₛ values, and find the value of Vᵣₘₛ which produces the highest stacking power from a semblance spectrum. Utilizing this technique saves significant computing power. Other models and methods require detailed knowledge of the geological layers between the receiver and the seismic source. Disclosed embodiments improve on the existing methods by providing a useful microseismic monitoring technique without requiring the use or development of a depth velocity model and without requiring detailed study and/or knowledge of the underlying geological layers.

The disclosed scanning approach may be used for other unknown parameters. Note, the above velocity concept is valid for both P- and S-wave velocities. For surface monitoring, P wave is generally more dominant on the vertical component, and S wave is generally more dominant on the horizontal component.

RMS Velocity Analysis with a Reference Event at a Known Location

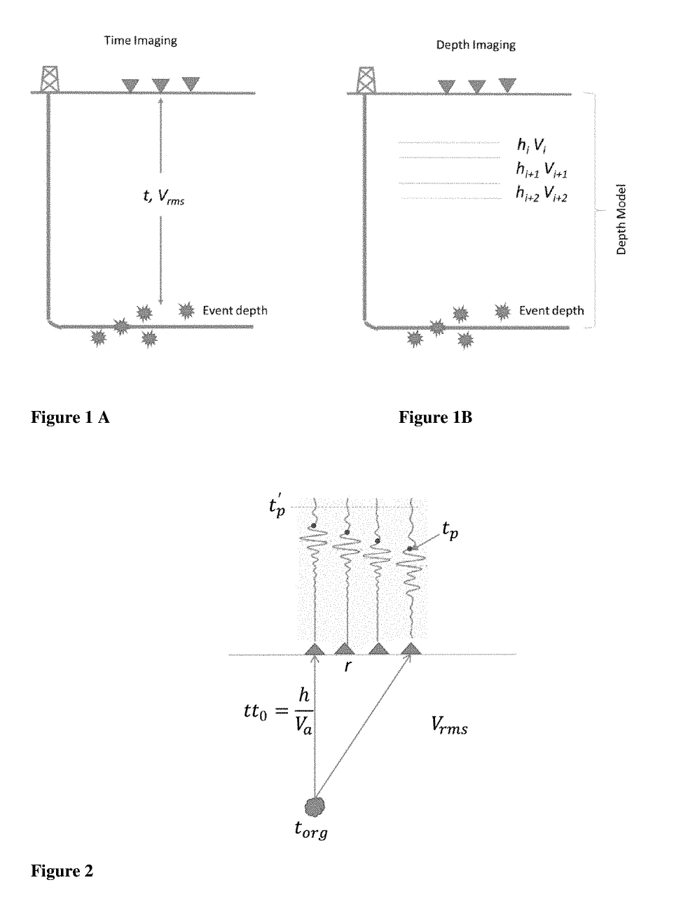

When using disclosed embodiments, we can assume that the waveform of a reference event such as, but not limited to a perforation shot, drop-ball event, or microseismic event, is available (FIG. 1). To utilize the disclosed embodiments, we determine an average seismic wave velocity (Vₐ) and the RMS velocity (Vᵣₘₛ) between the source point in depth and at the surface recording level. In many embodiments, we determine a related to P-waves specifically although some disclosed embodiments may be applied to S-waves additionally or alternatively. The relationship between the event location arrival time, and the RMS velocity is described by equations 2 and 3 below.

$$\begin{matrix}{( {t}_{p} - {t}_{org} )}^{2} = \frac{{r}^{2}}{{V}_{rms}^{2}} + {( {tt}_{0} )}^{2} , & ( 2 ) \\ {tt}_{0} = {t}_{p}^{′} - {t}_{org} , & ( 3 )\end{matrix}$$

where tₚ is the arrival time (clock time) of the wave recorded at a receiver; r is the horizontal distance (offset) between the source and receiver; Vᵣₘₛ is the RMS velocity; t_{org} is the origin time (clock time) of the source occurrence; tt₀ is the vertical travel time from the source upright to a surface point at the horizontal source-receiver offset r=0 (see FIG. 2). Note that tt₀ may be a virtual time, where there may not be a receiver. t′ₚ is the clock arrival time of tt₀. Equation (2) is related to the hyperbolic equation utilized in the normal moveout correction with the source as the image point in comparison with the traditional seismic exploration. The origin time t_{org} is generally unknown for any recorded event, and we can eliminate the original time using the equation (2) and (3) to obtain the following equation (4).

$${( {t}_{p} - {t}_{p}^{′} + {tt}_{0} )}^{2} = \frac{{r}^{2}}{{V}_{rms}^{2}} + {( {tt}_{0} )}^{2} . \qquad ( 4 )$$

Therefore, tₚ, the arrival time for each receiver on the surface can be calculated by the following equation (5) if given a set of parameters (t′ₚ, tt₀, Vᵣₘₛ, r):

$${t}_{p} = \sqrt{\frac{{r}^{2}}{{V}_{rms}^{2}} + {( {tt}_{0} )}^{2}} + {t}_{p}^{′} - {tt}_{0} \qquad ( 5 )$$

For the RMS and average velocity analysis with a known event location, the horizontal distance (offset r) between the source and each receiver is known to us, the unknown parameters that we need to determine include tt₀, Vᵣₘₛ, and Vₐ=h/tt₀. However, equation (5) suggests that we must scan three parameters t′ₚ, tt₀, and Vᵣₘₛ. Equation (5) determines a travel time curve which consists of the arrival times of multiple receivers given a set of the unknown parameters (t′ₚ, tt₀, Vᵣₘₛ). Note that the scanning ranges of tt₀ and Vᵣₘₛ are small, since they have a limiting physical definition, while t′ₚ is the clock time on seismogram with sample by sample moving along. We can stack the waveforms along the travel time curve of the P wave using the following semblance equation

$$f ( {t}_{p}^{′} , {tt}_{0} , {V}_{rms} ) = \frac{{[ {\sum }_{i}^{nr} {u}_{i} ( {t}_{p}^{i} ( {t}_{p}^{′} , {tt}_{0} , {V}_{rms} ) ) ]}^{2}}{nr {\sum }_{i}^{nr} {[ {u}_{i} ( {t}_{p}^{i} ( {t}_{p}^{′} , {tt}_{0} , {V}_{rms} ) ) ]}^{2}} , \qquad ( 6 )$$

In Equation 6, nr is the number of receivers; uᵢ is the waveform data at i^{th} receiver and tₚⁱ is the arrival time calculated with equation (5) at the i^{th} receiver. For any given parameter vector (t′ₚ, tt₀, Vᵣₘₛ), we calculate the arrival time tₚⁱ for each receiver and then stack the waveforms along the arrival time curve according to equation (6); thus we obtain the semblance f (t′ₚ, tt₀, Vᵣₘₛ).

The maximum semblance value of the stacked waveform f(t′ₚ, tt₀, Vᵣₘₛ) is associated with the optimal determined RMS velocity. To facilitate the RMS velocity picking, we convert the 3D volume of the semblance f(t′ₚ, tt₀, Vᵣₘₛ) into a 2D plane following equation (7):

$${f}^{′} ( {t}_{p}^{′} , {V}_{rms} ) = {max}_{{tt}_{0}} \{ f ( {t}_{p}^{′} , {tt}_{0} , {V}_{rms} ) \} . \qquad ( 7 )$$

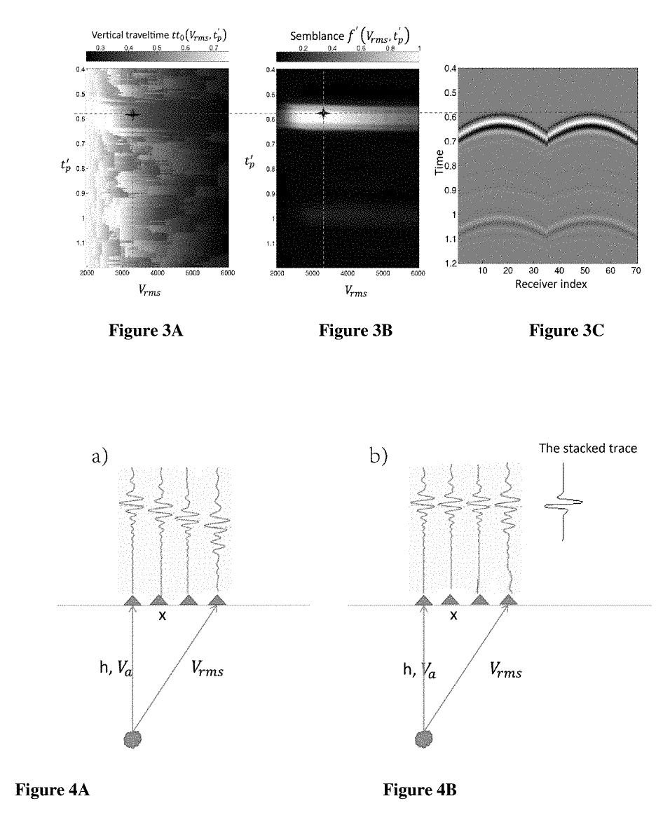

For any given parameters t′ₚ and Vᵣₘₛ, we find a vertical travel time tt₀(t′ₚ, Vᵣₘₛ), which maximizes the semblance value f(t′ₚ, tt₀, Vᵣₘₛ). We obtain both the vertical travel time tt₀ associated with the point (t′ₚ, Vᵣₘₛ) in a 2D plane as shown in FIG. 3a due to equation (7), and the maximum semblance value f′(t′ₚ, Vᵣₘₛ) as shown in FIG. 3b simultaneously. FIG. 3c shows the corresponding data which may be used for quality control. Initially for perforation shot data, we can select an RMS velocity according to the distribution of the semblance value f′ shown in FIG. 3b. If we assume that the user picks a point (Vᵣₘₛ^{picked}, tₚ^{picked}) with the largest semblance value f′ , then the corresponding vertical travel time tt₀^{picked} is obtained simultaneously at the picked point as shown in FIG. 3a. Since we know the depth h_{per f} of the perforation shot, we can determine the average velocity using the relationship: Vₐ=h_{per f}/tt₀^{picked}. The average velocity is utilized to convert the microseismic event from the time domain to the depth domain for the subsequent location process.

In some embodiments, the RMS and average velocity analysis may be summarized as follows:
1) Select the ranges for the three scanning parameters: the vertical arrival time t′ₚ, the vertical travel time tt₀, and Vᵣₘₛ.
2) Calculate the semblance f (t′ₚ, tt₀, Vᵣₘₛ) for each set of parameters (t′ₚ, tt₀, Vᵣₘₛ) using equation (6).
3) Convert the 3D volume of the semblance f(t′ₚ, tt₀, Vᵣₘₛ) into a 2D plan utilizing equation (7), and obtain both the vertical travel time and maximum semblance distribution in a 2D plane as shown in FIGS. 3a & 3b.
4) Select the RMS velocity (Vᵣₘₛ) associated with the point at the maximum semblance in FIG. 3b, and obtain the corresponding vertical travel time (tt₀) simultaneously as shown in FIG. 3a.
5) Convert the vertical travel time (tt₀) to the average velocity Vₐ using the known depth of the perforation shot (Vₐ=h_{per f}/tt₀^{picked}).

The scanning ranges for the three parameters t′ₚ, tt₀, and Vᵣₘₛ are useful for obtaining accurate results. The range of time t′ₚ is generally from the beginning of the recorded data to the end. However, the vertical travel time tt₀ is only related to the average velocity and the depth of the source. Therefore, the scanning range of the vertical travel time tt₀ may be estimated and/or limited if we know the general velocity range of the media. This is not required, but in some alternative embodiments, this velocity range can be derived from the well log of the production well. Embodiments do not require knowledge of the general velocity of the media, but that information may be used to further reduce the calculations associated with the scanning range.

Detection and Location of Events with a RMS Velocity

Using the RMS velocity determined at the velocity analysis step utilizing a reference shot with known location (e.g., perforation shot, drop-ball event, or microseismic event), we can locate microseismic events and return parameters (sₓ, s_{y}, s_{z}, t_{org}) for such events. It will be appreciated that (sₓ) represents a location on x-axis of the surface and (s_{y}) represents a location on y-axis of the surface. Together these horizontal location parameters represent the horizontal location. Parameter (s_{z}) represents a location on the z-axis relating to the depth of the seismic event. We initially search for the event location in the time domain. Unlike traditional time imaging methodologies, we search for the location of unknown sources of microseismic waves without analysis of the sub surface reflectors rather than utilizing a known source of seismic waves to analyze subsurface reflectors. The solutions which we search for include the horizontal location parameters (sₓ, s_{y}) and the vertical travel time tt₀, and s_{z}=Vₐtt₀. The disclosed embodiments, do not solve for the depth of the microseismic event directly based on seismic data but instead convert the vertical travel time tt₀ to the depth of the event using the average velocity. The disclosed embodiments and techniques allow for faster location of microseismic events due to reduced total processing and by eliminating the need to develop a depth velocity model. The horizontal distance r between the event and the receiver can be determined using the following equation (8) in the layered medium:

r=\sqrt{(sₓ−rₓ)²+(s_{y}−r_{y})²}, (8)

In equation (8), the rₓ and r_{y} are the receiver location in horizontal direction, and sₓ and s_{y} are the event location parameters in the plan view. With the RMS velocity, for the given parameter set (t′ₚ, sₓ, s_{y}, tt₀), the arrival time curve which consists of multiple arrival times at the receivers can be determined using equations (5). In the described embodiments, we may stack the waveforms along the arrival time curve to obtain the semblance value, which is a function of the source location as shown in equation (9):

$$F ( {t}_{p}^{′} , {s}_{x} , {s}_{y} , {tt}_{0} ) = \frac{{[ {\sum }_{i}^{nr} {u}_{i} ( {t}_{p}^{i} ( {t}_{p}^{′} , {s}_{x} , {s}_{y} , {tt}_{0} ) ) ]}^{2}}{nr {\sum }_{i}^{nr} {[ {u}_{i} ( {t}_{p}^{i} ( {t}_{p}^{′} , {s}_{x} , {s}_{y} , {tt}_{0} ) ) ]}^{2}} \qquad ( 9 )$$

In preferred embodiments, the event detection and location processes are performed simultaneously. When a seismic event is identified through the stacking process, the event location parameters are also available. We can scan the data from as early as the beginning to as late as the end of the monitoring project to detect events with a semblance value larger than a given threshold value. For any given time t′ₚ, we can find the event location with the largest semblance value following equation (10):

$${F}^{′} ( {t}_{p}^{′} ) = {max}_{{s}_{x} , {s}_{y} , {tt}_{0}} F ( {t}_{p}^{′} , {s}_{x} , {s}_{y} , {tt}_{0} ) . \qquad ( 10 )$$

There may be an event detected at time t′ₚ if the semblance value F′(t′ₚ) is larger than the selected threshold value. In addition, we may also obtain the horizontal location parameters and vertical travel time, which maximize the semblance value at time t′ₚ.

The event detection and location steps of certain embodiments may be summarized as follows:
1) Select ranges for the four scanning parameters: t′ₚ, sₓ, s_{y}, tt₀ for locating events in time domain.
2) Calculate the semblance F(t′ₚ, sₓ, s_{y}, tt₀) for each set of parameters utilizing equation (9).
3) Calculate a semblance trace F′(t′ₚ) utilizing equation (10) to detect the events. If the semblance magnitude at the time sample t′ₚ is larger than a predetermined threshold value, then an event is detected.
4) Output the corresponding parameters (sₓ, s_{y}, tt₀) at maximum semblance value at detected time sample t′ₚ according to the semblance stacking image.
5) Convert the vertical travel time tt₀ to the depth of the detected event by s_{z}=Vₐ·tt₀.

Elevation Corrections

The utilized receivers of an array may not always be located at the same depth with regard to the topography on the surface. In some embodiments, we utilize a constant velocity to calculate the time shifts caused by the topography, and then remove the time shifts to correct the receivers to the same depth. The time shifts can be defined as following equation (11):

$$Δ T = \frac{Δ h}{v} \qquad ( 11 )$$

In equation (11) Δh is the depth difference between the receiver and reference plane. In certain embodiments, the constant velocity can be estimated from a well log of the production well.

Residual Statics Corrections

The residual statics data may affect a stacking image. To improve the stacking image, we utilize the travel time residuals between the synthetic and real travel times to approximate the residual statics of the receivers. In certain embodiments, we select a strong microseismic event with high signal to noise ratio, and calculate the synthetic travel times with the location result obtained from a stacking method. FIG. 4 shows the waveforms of an exemplary event before and after normal moveout correction according to the calculated synthetic travel times. The P phase with high signal to noise ratio is generated by stacking the waveforms in a given window as shown in FIG. 4b. The residual statics of each receiver can be estimated through the cross-correlation between the stacked P phase and the waveform in a time window after normal moveout correction (FIG. 4b). The travel time residuals are generally due to the lateral heterogeneity in the near surface and the 1D layered assumption of the medium. To improve the stacking image, we incorporate these effects to the residual statics.

In certain embodiments, the disclosed methods may be applied to seismic data with low to noise ratios. In some embodiments, the signal to noise ratio is less than 1. In certain embodiments, it is not possible to manually identify seismic waves and/or P-waves due to the amount of noise.

### Exemplary Embodiment

We utilize an example to illustrate the steps of the one of many exemplary embodiments. It will be understood that this is an exemplary embodiment and that the specific features and limitations of this embodiment are not necessarily present in other or all disclosed embodiments.

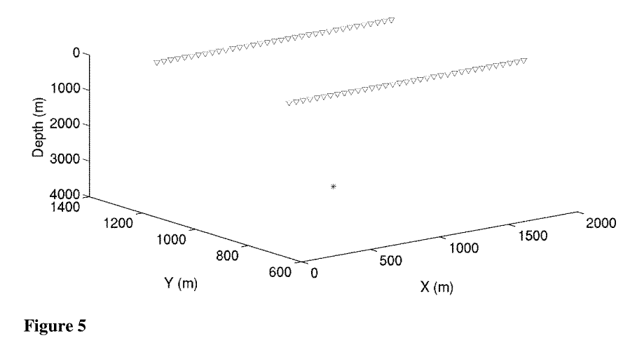

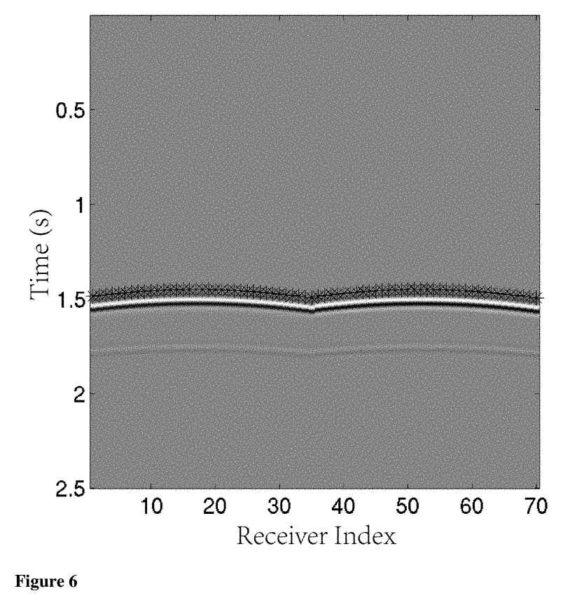

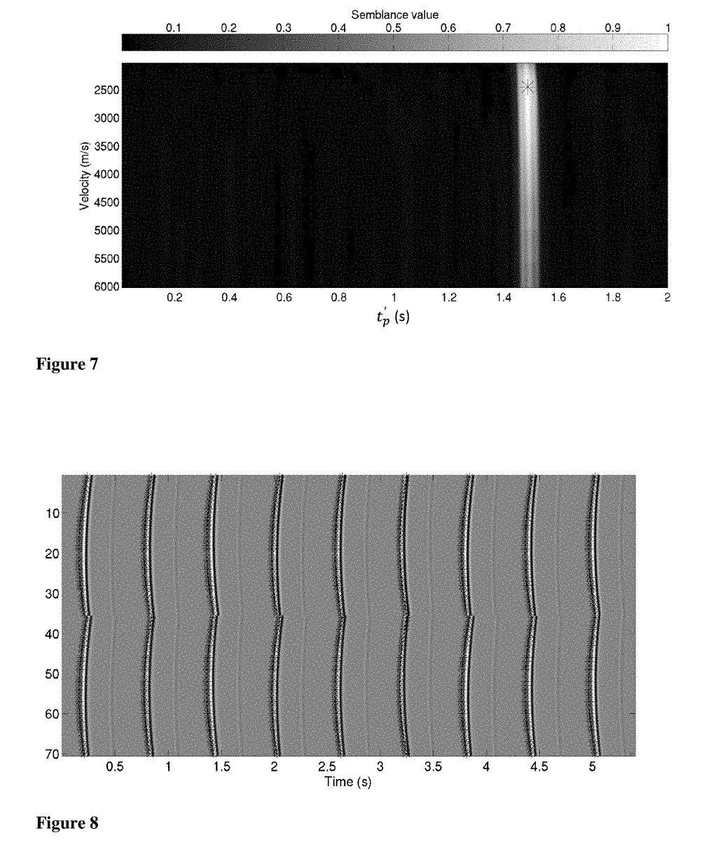

In an exemplary embodiment, we assume the microseismic events can be recorded by two receiver lines as shown in FIG. 5. In an RMS velocity analysis, we utilize an event with known location (e.g. perforation shot) to determine an appropriate RMS velocity. FIG. 6 shows the synthetic waveform generated by a perforation shot in FIG. 5 (star). In this example, we assume the RMS velocity range to be from 2,000 m/s to 6,000 m/s, and the velocity interval is 50 m/s. For each RMS velocity, we calculate the arrival time curve using equation (5) and stack waveforms along the arrival time curve to obtain a semblance value as shown in FIG. 7. FIG. 7 depicts the 2D semblance distribution determined by equation (7). The star in FIG. 7 denotes the picked RMS velocity and is the peak of the stacking image. The corresponding vertical travel time tt₀ which maximizes the semblance function is 0.468 s. The depth of the perforation shot is known to be 1,500 m in this example. Therefore, the average velocity is 3,200 m/s=1500 m/0.468 s. The average velocity shall be utilized for the time and depth conversion in the subsequent event location.

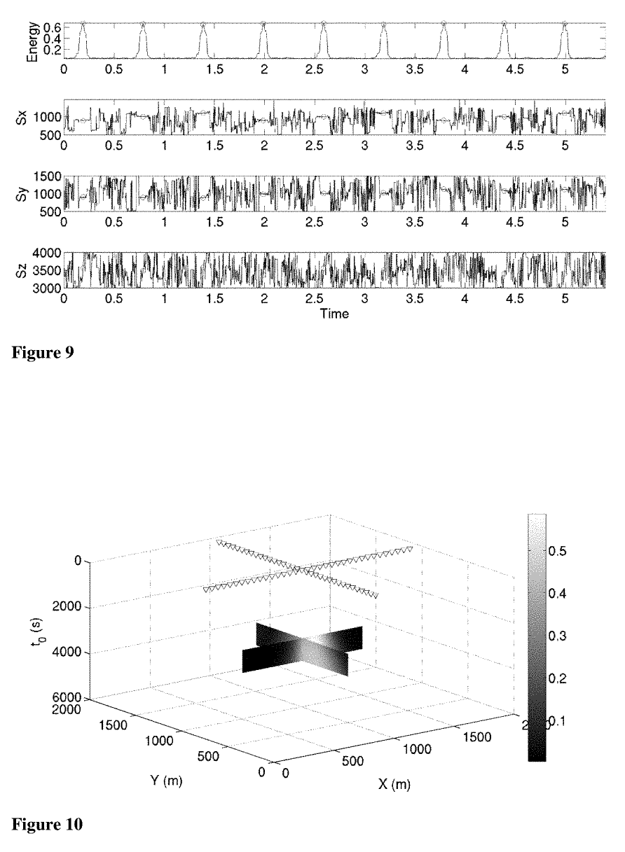

Event location and detection are performed simultaneously after obtaining the best RMS velocity. FIG. 8 shows the continuous records for the receiver arrays. There are 9 microseismic events in total shown. In this example, we assume the horizontal location parameters are in the ranges from 500 m to 1,500 m, and the vertical travel time is in the range from 0.25 s to 0.75 s. We calculate the semblance values for the potential horizontal location and time grid nodes utilizing the resolved RMS velocity. The event depth is obtained by the conversion from the vertical travel time with the average velocity of 3,200.0 m/s. Therefore, we obtain the semblance value for each time sample and the corresponding best location parameters by equation (10) as shown in FIG. 9. If the maximum semblance value in a time window is larger than a given or predetermined threshold value, then there is an event detected in the time window. In certain embodiments, the predetermined threshold value may be set at about 0.3. In addition, we can obtain the best event location corresponding to the largest semblance value. We also analyze the uncertainty of the event location by the 3D image as shown in FIG. 10. Since the equation (8) determines a 4D image, we can output the 3D location image for a given time t′ₚ (FIG. 10).

Advantages and Positive Effects

Disclosed embodiments introduce the velocity analysis and normal move out technology to the field of microseismic monitoring to locate an unknown source of seismic waves by analyzing the direct waves produced by that unknown source. Disclosed embodiments apply a scanning and stacking methodology to obtain a RMS velocity. The layered depth velocity model, which may be poorly constrained, is entirely avoided using disclosed embodiments. Preferred embodiments utilize the RMS velocity to detect and locate the microseismic event automatically. This method is significantly more efficient for processing surface data with large amounts of noise and also effective for traditionally difficult situations including, but not limited to, those involving limited information for constraining the depth velocity model. Additionally, the synthetic traveltime calculation is simplified by the disclosed RMS velocity method.

For scanning and stacking with a depth velocity model, the traveltime table should be calculated in advance by using a ray tracing method and loaded into memory during the detection and location process. However, using disclosed embodiments, it is sufficient to calculate the traveltimes using an analytical equation during the detection and location process without preserving a traveltime table. Disclosed embodiments, are not required to maintain a large traveltime table in memory during the stacking procedure as in the traditional method since the travel time can be calculated by an analytical equation with a RMS velocity. This feature allows for faster and more efficient determination of the location of microseismic events with a reduced need for processing. The reduced calculation and processing requirements associated with disclosed embodiments allow embodiments to be utilized in unconventional oil and gas production faster and at reduced costs. Additionally, disclosed embodiments allow for real-time or near real-time location and detection of microseismic events which, in turn, allows for real-time or near-real time fracturing mapping in some disclosed embodiments.

Many disclosed embodiments are highly tailored for use with unconventional oil and gas production methods such as hydraulic fracturing. In most embodiments, an initial microseismic event at a known depth is a required step. This event may be a perforation shot or ball drop event which occurs within a well bore at a known depth. Utilizing a perforation shot or ball drop as a known depth seismic events create a basis for determining the RMS velocity and average velocity of seismic waves through multiple potentially diverse geological layers without intimate knowledge of each layer or a variety of other potentially confounding variables. The disclosed methods and techniques save a significant amount of time over the established methods. Disclosed embodiments allow the use of simplified and streamlined seismic event location which represents a dramatic improvement over the customary techniques of seismic monitoring. Development of an accurate depth velocity model can take time from hours to multiple days or even weeks. Disclosed embodiments allow the user to calibrate and utilize the disclosed streamlined method in real-time or near real-time without requiring days or even weeks of signal processing.

Due to the ease of processing and deployment of the disclosed embodiments, a new RMS velocity value can be established for each stage of a well that is perforated. Certain embodiments relate to a method of locating seismic events utilizing more than one perforation shot to establish more than one RMS velocity for multiple given areas. In some embodiments, the multiple RMS velocities may be averaged or combined in order to maintain the use of a single RMS velocity over a larger area in order to maximize the speed and simplicity and minimize the necessary processing requirements associated with the disclosed techniques.

Some disclosed embodiments relate to an improved method of signal processing which results in faster processing with less fewer calculations required as compared to traditional methods. Such disclosed embodiments do not require the use of a depth velocity model which requires accurate and detailed knowledge of the geological layers between a source of seismic or microseismic activity and a detection device. In some embodiments, the location of a microseismic event may be determined and reported within about 1 day of the event occurring. In certain embodiments, the location of the event may be determined and reported in less than 3 hours, or less than 1 hour, or less than 30 minutes, or less than 10 minutes, or less than 5 minutes, or less than 3 minutes, or less than 1 minute from the event actually occurring. In certain embodiments, the location of the event may be determined and reported in more than 1 minute from the event actually occurring. In certain embodiment only a single root mean square velocity value is used to determine the location of microseismic events without the use of a depth velocity model.

Some disclosed embodiments relate to a system for locating microseismic events. Embodiments of such systems may comprise a geophones, receivers and/or arrays thereof configured to monitor and/or detect seismic waves. In some embodiments, fiber optic cables and/or digital acoustic systems, may be used as, instead of, or in addition to a monitoring array for detecting seismic waves. In certain embodiments fiber optic cable may be buried at a depth from the surface and used to detect seismic waves. In some alternative embodiments, existing fiber optic cable strands may be used to monitor seismic activity from vertical or horizontal wells in addition to the use of disclosed surface monitoring systems.

Some disclosed embodiments relate to a method of hydraulic fracturing comprising the steps of drilling and casing a gas production well, wherein the well comprises a horizontal section in a formation layer; perforating the well at a known location using a perforation shot; monitoring and recording the seismic waves produced by the perforation shot using an array of receivers; determining the root mean square velocity and average velocity using the recorded seismic wave data from the perforation shot; pumping fracturing fluid into the formation layer; monitoring and recording seismic wave data for microseismic events; determining the location of any detected microseismic events. Some embodiments further comprise developing a fracture map based on the determined location of detected microseismic events and modifying a well treatment or stimulation operation in response to the facture map. Potential actions in response to a developed fracture map include but are not limited to, increasing or decreasing the pressure at which drilling and/or fracturing fluid are pumped into the well, modifying the chemistry of the fracturing fluid and/or proppant, drilling a subsequent wells, modify the spacing of subsequent wells, controlling and/or modifying the direction of subsequent well bores.

Certain embodiments relate to a system for locating microseismic events related to hydraulic fracturing, the system comprising a plurality of geophones arranged in an array wherein the array is operably connected to a processor, and wherein the processor is configured to record and maintain a record of seismic data and known or determined parameters. In some embodiments, the system is configured to determine the location of microseismic events based on the maintained record. In some of these embodiments, the record does not include a depth velocity model and/or information regarding multiple geological layers. In certain embodiments, the record comprises only a single root mean square velocity value and a single average velocity value for seismic waves traveling between a seismic event and a plurality of geophones.

1. A method of hydraulic fracturing gas production comprising:
drilling and casing a gas production well, wherein the well comprises a horizontal section within a formation layer;
perforating the horizontal section of the well at a known location using a perforation shot;
monitoring seismic waves produced by the perforation shot using an array of geophones;
determining a root mean square velocity value and an average velocity value using the seismic wave data from the perforation shot and the known location of the perforation shot;
pumping fracturing fluid into the formation layer;
monitoring subsequent seismic wave data using the array of geophones;
identifying microseismic events;
determining the horizontal location of an identified microseismic events and vertical travel time of seismic waves resulting from the microseismic event.

2. The method of claim 1, further comprising the step of determining the depth of the identified microseismic event utilizing the vertical travel time and average velocity value;

3. The method of claim 2, further comprising the step of generating a formation fracture map based on the determined location of a microseismic event.

4. The method of claim 3, further comprising drilling a second well at a location, wherein the location of the second well is based on the fracture map.

5. The method of claim 3, further comprising drilling a second well, wherein the direction of the second well bore is based on the fracture map.

6. The method of claim 1, wherein the step of determining the horizontal location of an identified microseismic event is conducted in the absence of a depth velocity model;

7. A system for locating microseismic events related to hydraulic fracturing, the system comprising:
a plurality of geophones arranged in an array wherein the array is operably connected to a processor, and wherein the processor is configured to record and maintain a record of seismic data; wherein the processor is configured to determine the location of microseismic events based on the maintained record, and wherein the record does not require a depth velocity model or information regarding multiple geological layers.

8. The system of claim 7, wherein the record comprises a single root mean square velocity value and a single average velocity value for seismic waves traveling between a seismic event and the plurality of geophones.

9. The system of claim 8, wherein the root mean square velocity and average velocity are determined based on seismic waves resulting from a reference seismic event occurring at a known depth, and wherein that depth is at least 1,000 m below ground level.

10. A method of locating a microseismic event in the absence of a depth velocity model, the method comprising:
initiating an intentional seismic event at a known location;
monitoring seismic waves related to the intentional seismic event using a surface monitoring array, wherein the monitoring array comprises a plurality of geophones;
determining a root mean square velocity and average velocity of the seismic waves traveling from the intentional seismic event to the plurality of geophones;
monitoring subsequent seismic waves to identify a subsequent microseismic event;
identifying the location of the subsequent microseismic event based on the subsequent seismic waves, root mean square velocity, and average velocity without the use of a depth velocity model.

11. The method of claim 10, wherein the intentional seismic event is a perforation shot in a gas production well.

12. The method of claim 10, wherein the step of identifying the location maximizes a semblance value function.

13. The method of claim 10, further comprising the step of stacking seismic waves in order to increase the ratio of seismic wave signal to background noise.

14. The method of claim 10, wherein the location of the intentional seismic event is at least 1,000 m below ground level.
